(19) United States
(12) Patent Application Publication
(10) Pub. No.: US 2025/0390377 A1
(43) Pub. Date: Dec. 25, 2025

(54) RETRIEVING USER DATA AND CYCLIC REDUNDANCY CHECK INFORMATION USING A SINGLE ACCESS OPERATION

(71) Applicant: Micron Technology, Inc., Boise, ID (US)

(72) Inventors: Marco SFORZIN, Cernusco Sul Naviglio (IT); Su Wei LIM, Penang (MY); Daniele BALLUCHI, Cernusco Sul Naviglio (IT); Nicola DEL GATTO, Cassina De' Pecchi (IT)

(21) Appl. No.: 19/191,828

(22) Filed: Apr. 28, 2025

Related U.S. Application Data
(60) Provisional application No. 63/663,486, filed on Jun. 24, 2024.

(51) Int. Cl. G06F 11/10

(52) U.S. Cl. CPC G06F 11/1004

(57) ABSTRACT

In some implementations, a memory controller may retrieve, via a first access operation, a block of user data and cyclic redundancy check (CRC) information associated with the block of user data, wherein the block of user data is retrieved using the one or more data pins, and wherein the CRC information is retrieved using one or more data mask inversion pins. The memory controller may determine, using the block of user data and the CRC information, whether the block of user data includes one or more bit errors. The memory controller may determine, based on whether the block of user data includes the one or more bit errors, whether to perform at least one of retrieving, via a second access operation, error correction information associated with the block of user data, or initiating a redundant array of independent disks error correction operation associated with the block of user data.

### CROSS-REFERENCE TO RELATED APPLICATION

This Patent Application claims priority to U.S. Provisional Patent Application No. 63/663,486, filed on Jun. 24, 2024, entitled “RETRIEVING USER DATA AND CYCLIC REDUNDANCY CHECK INFORMATION USING A SINGLE ACCESS OPERATION,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to retrieving user data and cyclic redundancy check (CRC) information using a single access operation.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. Advancements in data storage involve data correction protocols and redundancy schemes, such as redundant array of independent disks (RAID) error correction operations. These operations enhance data integrity and fault tolerance while balancing performance with resource allocation.

### BRIEF DESCRIPTION OF THE DRAWINGS

FIG. 1 is a diagram illustrating an example system capable of retrieving user data and CRC information using a single access operation.

FIG. 2 is a diagram illustrating another example system capable of retrieving user data and cyclic redundancy check (CRC) information using a single access operation.

FIGS. 3A-3B are diagrams of examples associated with redundant array of independent disks (RAID) error correction operations.

FIG. 4 is a diagram of an example of retrieving user data and CRC information using a single access operation.

FIG. 5 is a flowchart of an example method associated with retrieving user data and CRC information using a single access operation.

### DETAILED DESCRIPTION

In the context of advanced memory technology, particularly involving compute express link (CXL) devices, redundant array of independent disks (RAID) error correction operations may be employed to provide redundancy and enhance data integrity. RAID error correction operations may be designed to correct large clusters of errors, such as errors that may occur when an entire die of a memory array fails. These mechanisms may be crucial within environments demanding high reliability, availability, and serviceability (RAS).

However, standard RAID error correction operations present several challenges, notably in terms of bandwidth and amplification penalties during data recovery processes. The necessity of accessing multiple memory blocks for verifying and updating data introduces read and write amplification, resulting in increased latency and decreased data throughput. Specifically, read amplification arises from the requisite for consecutive memory accesses in different block lengths, whereas write amplification is a consequence of the RAID amplifying effect that obliges multiple read and write operations to maintain parity and correct data errors. These amplification issues exacerbate as the volume of write operations intensifies, emphasizing the need for optimization.

Some implementations described herein provide a memory system that enhances the efficiency of RAID-based redundancy and error correction in CXL devices or similar memory devices. For example, the memory system may be configured to retrieve a block of user data and associated cyclic redundancy check (CRC) information via a first access operation using data pins for the user data and data mask inversion (DMI) pins for the CRC information. The memory system may determine whether the block of user data includes bit errors using the retrieved CRC information and may decide whether to perform a second access operation to retrieve error correction information, or to initiate a RAID error correction operation, based on whether the block of user data includes bit errors.

In this way, when the block of user data is free of bit errors, additional error correction information retrieval is negated, thereby minimizing access operations and system overhead. This streamlined process decreases bandwidth penalties, thereby improving throughput, and contributes to conserving network resources in the data exchange among CXL devices. Furthermore, by optimizing first access operations and selectively engaging error correction processes, the proposed memory system advances the reliability and robustness of RAID-based memory systems within CXL devices. In this way, the techniques described herein may foster resource-efficient error management while maintaining high RAS standards crucial for dependable system operation and conserving resources by reducing unnecessary data accesses and memory wear.

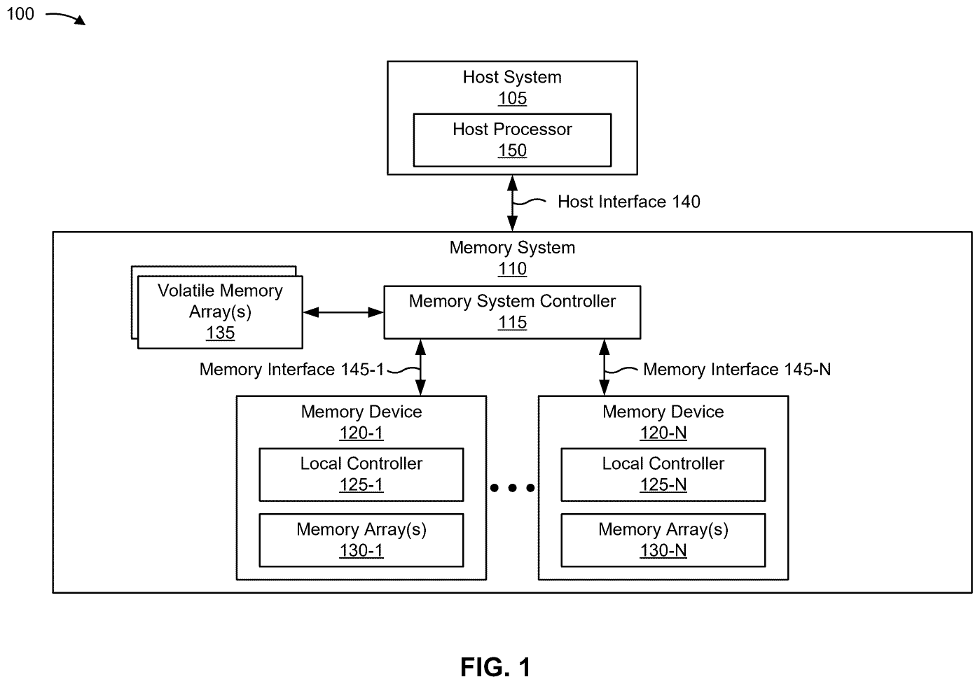

FIG. 1 is a diagram illustrating an example system 100 capable of retrieving user data and CRC information using a single access operation. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

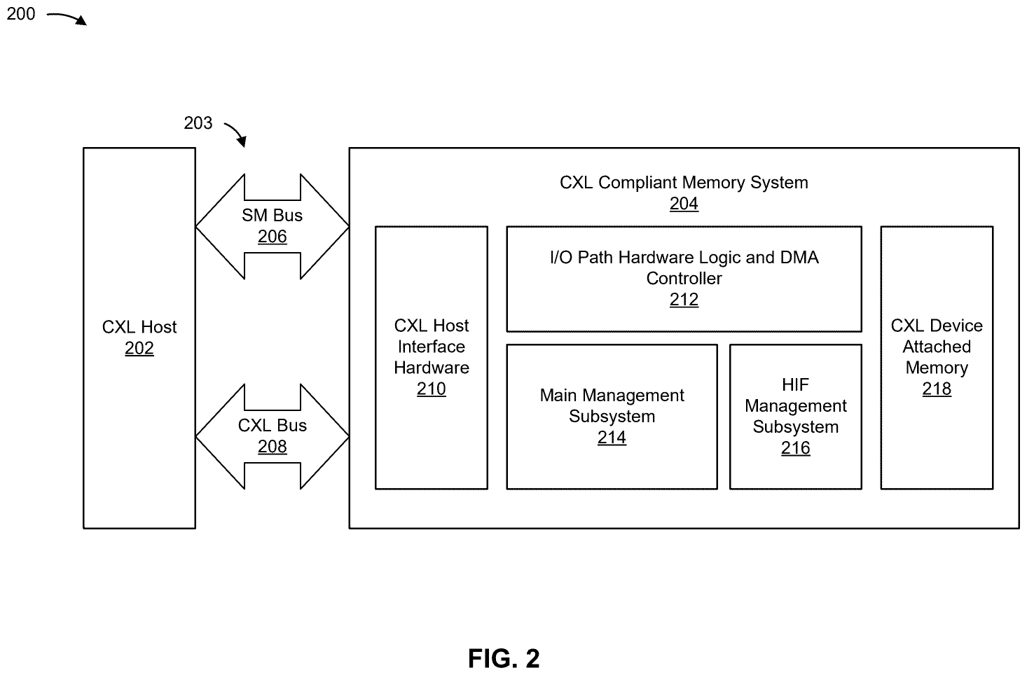

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to retrieve, via a first access operation, a block of user data and CRC information associated with the block of user data, wherein the block of user data is stored in a first portion of a memory associated with one or more data pins and is retrievable, during the first access operation, using the one or more data pins, and wherein the CRC information is stored in a second portion of the memory associated with one or more DMI pins and is retrievable, during the first access operation, using the one or more DMI pins; determine, using the block of user data and the CRC information, whether the block of user data includes one or more bit errors; and determine, based on whether the block of user data includes the one or more bit errors, whether to perform at least one of retrieving, via a second access operation, error correction information associated with the block of user data, or initiating a RAID error correction operation associated with the block of user data.

In some implementations, one or more systems, devices, apparatuses, components, and/or controllers of FIG. 1 may be configured to retrieve, from a DRAM via a burst length 32 (BL32) access of the DRAM, a user data block (UDB) and CRC information associated with the UDB, wherein the UDB is stored in a first portion of the DRAM and is retrievable, during the BL32 access of the DRAM, using one or more DQ pins, and wherein the CRC information is stored in a second portion of the DRAM and is retrievable, during the BL32 access of the DRAM, using one or more DMI pins; determine, using the UDB and the CRC information, whether the UDB includes one or more bit errors; and determine, based on whether the UDB includes the one or more bit errors, whether to perform at least one of retrieving, via a burst length 16 (BL16) access of the DRAM, error correction information associated with the UDB, or initiate a RAID error correction operation associated with the UDB.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of retrieving user data and CRC information using a single access operation. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a system management (SM) bus 206 and/or a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the SM bus 206 and/or the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

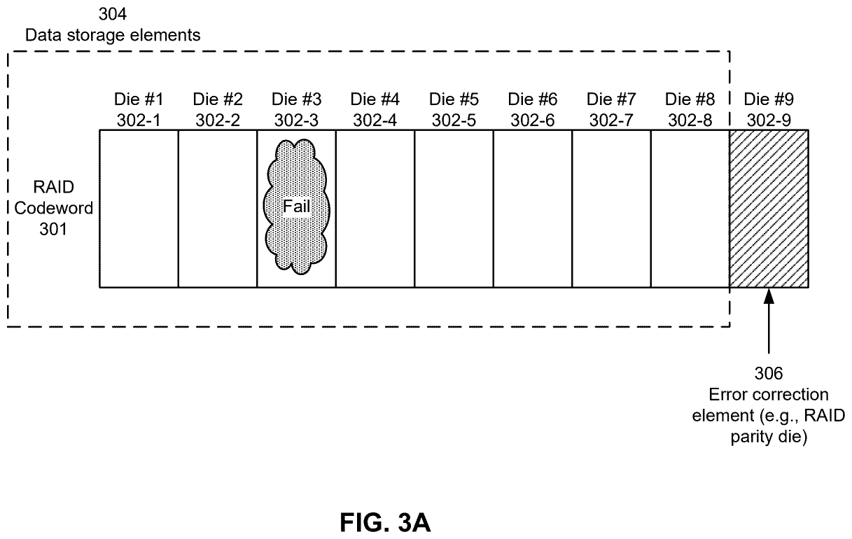

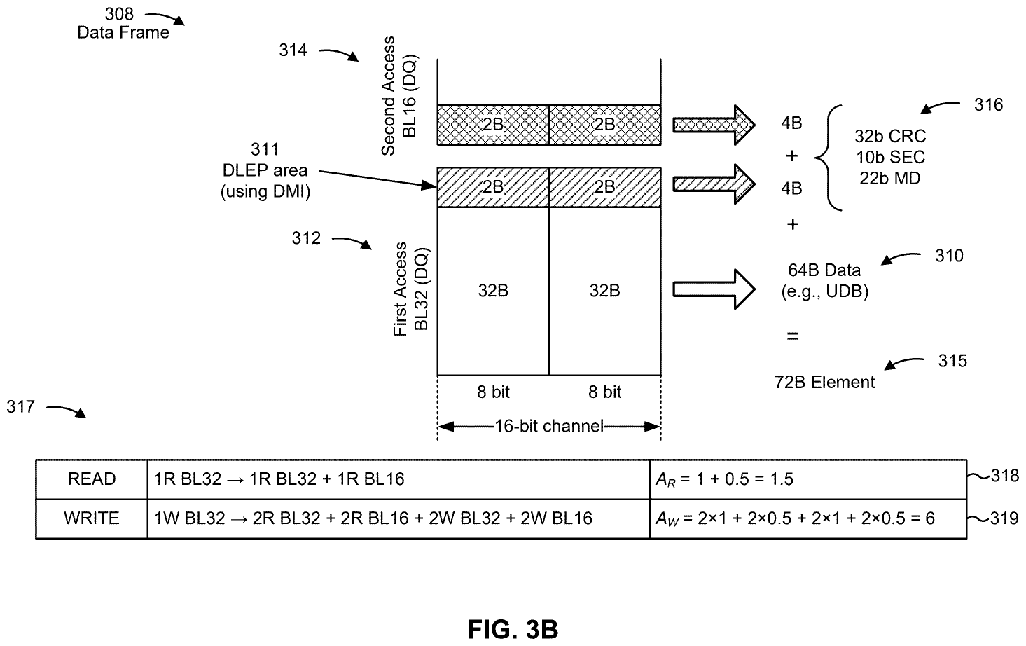

FIGS. 3A-3B are diagrams of examples associated with RAID error correction operations. The operations described in connection with FIGS. 3A-3B may be performed by the memory system 110 and/or one or more components of the memory system 110, such as the memory system controller 115, one or more memory devices 120, and/or one or more local controllers 125, and/or the CXL compliant memory system 204 and/or one or more components of the CXL compliant memory system 204, such as the main management subsystem 214 and/or the CXL device attached memory 218 (e.g., one or more memory controllers associated with the CXL device attached memory 218).

In some examples, a memory system may be configured to store host data across multiple memory locations, elements, and/or dies, such as for purposes of implementing a RAID error correction operation. In that regard, the memory system may be referred to as a RAID-based system. As shown in FIG. 3A, in some RAID-based systems, a memory system may store host data using multiple components (e.g., dies) that collectively form a RAID codeword 301. The RAID codeword 301 may include multiple elements 302 (e.g., multiple arrays, dies, disks, or the like), shown in FIG. 3A as a first element 302-1 through a ninth element 302-9. In that regard, the RAID codeword 301 may include a logical group of memory elements (e.g., elements 302) associated with one another for performing certain operations (e.g., write operations, read operations, or erase operations, among other examples). In some examples, utilizing the RAID codeword 301 that includes multiple elements 302 may enable a memory system to utilize distributed parity and/or redundancy techniques such that, if one element 302 of the RAID codeword 301 fails, the memory system may restore host data using the other elements 302 in the RAID codeword 301.

More particularly, as indicated by reference number 304, the RAID codeword 301 may be associated with multiple data storage elements, such as the first element 3021-1 through the eighth element 302-8 in the example shown in FIG. 3A, but which may include fewer or additional elements in some other examples. As indicated by reference number 306, the RAID codeword 301 may also be associated with an error correction element (e.g., a parity element), such as the ninth element 302-9 in the example shown in FIG. 3A. In some examples, the data storage elements may be used to store host data, and the error correction element may be used to stored parity bits used for error correction of the host data. In that regard, the data storage elements may form the payload of the RAID codeword 301 and the error correction element may form the parity of the RAID codeword 301. Put another way, in RAID-based systems, the data storage elements may be associated with a parity check payload, and the error correction element may be used to store parity bits associated with the parity check payload (e.g., RAID parity bits). In some cases, the parity bits may be derived from the party check payload, such as by performing an exclusive or (XOR) operation associated with the data bits stored on the data storage elements. For example, for a given bit location in the error correction element, a value of the error correction bit (e.g., parity bit) may be derived by performing an XOR operation using the data bits located at the given bit location of each data storage element. Although nine total elements 302 (e.g., dies) are shown in FIG. 3A, in some other examples, a RAID codeword may be associated with fewer or additional elements. For example, in some examples, a RAID codeword may be associated with eighteen elements, such as seventeen data storage elements and a one error correction element (e.g., one parity element), among other examples.

In some examples, the set of parity bits included at the error correction element may be used to recover any data that is lost on a given data storage element, such as due to a failed die, disk, array, or the like. For example, each data storage element (e.g., the first element 302-1 through the eighth element 302-8) may include a respective set of CRC bits, such as a set of CRC bits stored in space of the data storage element that is not used for storing host data. In this way, if an error occurs at a data storage element, such as if the third data storage element 302-3 fails (as shown in FIG. 3A as “Fail”), the memory system may detect the error using a CRC check associated with the third data storage element 302-3. Once detected, the memory system may use the remaining data storage elements (e.g., the first element 302-1, the second element 302-2, and the fourth element 302-4 through the eighth element 302-8), as well as the error correction element (e.g., the ninth element 302-9) to recover the lost data associated with the failed third element 302-3. For example, the memory system may derive the lost data by adding (e.g., in a bitwise fashion using an XOR operation) host data bits stored at the remaining data storage elements (e.g., the first element 302-1, the second element 302-2, and the fourth element 302-4 through the eighth element 302-8) to the parity bits stored at the error correction element (e.g., the ninth element 302-9). Accordingly, the set of CRC bits at each data storage element may be used to detect errors associated with the corresponding data storage element, and the parity bits may be used to correct the errors associated with a data storage element for which an error is detected.

In some examples, invoking a RAID error correction operation may be time and/or resource intensive. Accordingly, a memory system may employ additional error correction mechanisms capable of certain errors not associated with an entire failed die, such as single or multi-bit errors and/or single or multi-symbols errors, among other examples. More particularly, a memory system may utilize a single-error correction (SEC) code, such as for a purpose of reducing uncorrectable errors in a memory system and/or reducing a quantity of instances of RAID recovery in instances in which a data block includes a single bit error. In such memory systems, upon detecting the single bit error (e.g., using CRC information), the memory system may attempt to correct the error using an on-die ECC, such as an SEC code or the like. In such cases, if the error is not correctable using the SEC code or similar ECC (such as in a case of multiple bit errs and/or a failed die, or the like), the memory system may thereafter invoke the RAID error correction operation in an effort to recover the lost data.

More particularly, FIG. 3B shows an example data frame 308 associated with an SEC code. The example data frame 308 shown in FIG. 3B may be associated with a 64 byte UDB comprised of two memory components (e.g., dies) associated with a single channel (e.g., a 16-bit channel), but, in some other examples, a UDB may be associated with more or less data and/or more or less memory components. Each component (e.g., die) may be configured in a by-eight mode (sometimes referred to as “x8 mode”), meaning that the data stored therein may be accessed using 8 data pins (sometimes referred to as DQ pins) per component (e.g., each die may be associated with 8 bits of the 16-bit channel, as shown). Additionally, or alternatively, the data may be accessed using a burst length 32 (BL32) access, meaning that during a single access of the memory components, the memory system may be capable of accessing up to 32×8 bits of data (e.g., 256 bits (32 bytes) of data, shown in FIG. 3B as “32 B”), resulting in 64 bytes of total data between the two components, as indicated by reference number 310 (e.g., the two components shown in FIG. 3B may combine to form a 64 byte UDB, shown in FIG. 3B as “64 B”). Moreover, as indicated by reference number 311, the components may be associated with a storage portion separate from a data storage portion (e.g., a portion separate from the portion used to store the UDB), which may be accessible using a different set of pins, such as DMI pins, and/or which may sometimes be referred to as a direct link ECC protocol (DLEP) area. In that regard, during an access of the UDB shown in FIG. 3B, a memory controller may be capable of accessing, via the channel associated with the UDB, 64 bytes of host data via the DQ pins and 4 bytes of additional data via the DMI pins.

Additionally, or alternatively, in some aspects, a UDB may be associated with additional data (e.g., CRC information, ECC information, metadata, and/or similar information) that may be retrieved via a subsequent access of the memory (e.g., DRAM) using the DQ pins. For example, whenever the memory system accesses the UDB via a BL32 access, the memory system may perform an additional access, such as BL16 access, to retrieve additional information, such as CRC information, ECC information, metadata, and/or similar information. More particularly, as shown in FIG. 3B, to access the UDB, the memory system may perform a first access, as indicated by reference number 312, which may include retrieving the UDB by performing a BL32 access using the DQ pins and/or retrieving a portion of additional information associated with the UDB (e.g., a portion of CRC information, ECC information, and/or metadata) using the DMI pins to access the DLEP area. Additionally, the memory system may perform a second access, as indicated by reference number 314, which may include retrieving another portion of additional information associated with UDB (e.g., another portion of CRC information, ECC information, and/or metadata) using the DQ pins, such as by performing an additional BL16 access.

In some examples, the additional information associated with UDB (e.g., another portion of CRC information, ECC information, and/or metadata) may include 8 bytes of data, which may include 4 bytes of data retrieved using the DMI pins during the first access and an additional 4 bytes of data retrieved using the DQ pins during the second access (resulting in a 72 byte element that is accessed using the two access, as indicated by reference number 315). In that regard, even though the BL16 access results in access to 32 bytes of data overall (e.g., burst length 16×16 bit channel=256 bits (32 bytes)), in some examples only 4 bytes may be relevant to the accessed UDB. In some examples, the portion of memory used to store the additional information to be accessed during the second access (e.g., the BL16 access) is referred to herein as “extra area.” Put another way, in the example shown in FIG. 3B, the 64 byte UDB may be associated with a 4 byte extra area, which may be accessible via the BL16 access (e.g., the second access shown by reference number 314).

As indicated by reference number 316, in some examples the 8 bytes of additional data (e.g., the 4 bytes included in the DLEP area and the 4 bytes included in the extra area) may include 32 bits of CRC information (e.g., 32 parity bits used for a CRC), 10 bits of ECC information (e.g., 10 parity bits used for purposes of an SEC code), and 22 bits of metadata, among other examples. For example, the 4 bytes accessed from the DLEP area during the first access (e.g., the BL32 access) may be used to store the 32 parity bits used for the CRC, and/or the additional 4 bytes accessed from the extra area during the second access (e.g., the BL16 access) may be used to store metadata and SEC code information, such as the 22 bits of metadata and the 10 parity bits associated with an SEC code. Additionally, or alternatively, the UBD (e.g., the 64 bytes of user data) and the metadata bits (e.g., the 22 bits of metadata) may form a payload of a CRC codeword (e.g., the CRC codeword may include the 64 bytes of user data, the 22 bits of metadata, and the 32 bits of CRC parity data), and/or the CRC codeword may form a payload of an SEC codeword (e.g., the SEC codeword may include the CRC codeword including the 64 bytes of user data, the 22 bits of metadata, and the 32 bits of CRC parity data, as well as the 10 bits of SEC parity data). In such examples, the SEC information may be used by the memory system to correct single-bit errors in the UDB, thereby eliminating a need to invoke a RAID error correction operation for single bit errors, among other examples.

In some examples, configuring the memory components in this manner may result in a high read amplification factor (e.g., a ratio of an amount of data that is accessed at the storage medium compared to an amount of data requested by a host system) and/or a high write amplification factor (e.g., a ratio of an amount of data that is accessed at the storage medium compared to an amount of data written by a host system) of the memory system, and thus reduced bandwidth and/or increased latency of the memory system. More particularly, as indicated by reference number 317, configuring the memory components in the manner described above (e.g., storing 4 bytes of additional information in the DLEP area that is accessed during an initial (e.g., BL32) access and storing another 4 bytes of additional information in an extra area is accessible using DQ pins during a subsequent (e.g., BL16) access) may result in read operations that are associated with a read amplification factor (shown as A_{R} in FIG. 3B) of 1.5 and/or write operations that are associated with a write amplification factor (shown as A_{W} in FIG. 3B) of 6.

More particularly, the read amplification factor (e.g., A_{R}=1.5) may be due to the two accesses of the memory components during read operations, one in BL32 mode (normalized as BL32/BL32=1 in the equation indicated by reference number 318) and one in BL16 mode (normalized as BL16/BL32=0.5 in the equation indicated by reference number 318). Put another way, as indicated by the equation shown by reference number 318, for every BL32 read access requested by the host system, the memory system may perform a BL32 access plus a BL16 access, resulting in read amplification factor of 1.5.

Moreover, the write amplification factor (e.g., A_{W}=6) may be due to a RAID amplification factor (e.g., a ratio of an amount of data that is accessed at the storage medium for purposes of enabling RAID error correction operations compared to an amount of data written by a host system, which, in some examples, may be equal to 4) as well as due to the amplification factor (e.g., 1.5) caused by the two accesses of the memory components, one in BL32 mode and one in BL16 mode (e.g., 4×1.5=6). More particularly, when writing data to a memory, the memory system may first perform two read operations: one for the target UDB being written to and one for the RAID parity element associated with the UDB (e.g., the ninth element 302-9 described above in connection with FIG. 3A, but which may be the eighteen element in certain other architectures, among other examples). Based on comparing the data retrieved during the read operations and the data indicated by the host write command, the memory system may determine which bits of the UDB (and thus which corresponding bits of the parity element) are to be updated and may write data by performing a BL32 access and a BL16 access for the user data and by performing a BL32 access and a BL16 access for the parity information. In this regard, for every BL32 write access requested by the host system, the memory system may perform two BL32 read accesses (normalized as 2×1 (e.g., BL32/BL32) in the equation indicated by reference number 319), two BL16 read accesses (normalized as 2×0.5 (e.g., BL16/B132) in the equation indicated by reference number 319), two BL32 writes accesses (normalized as 2×1 in the equation indicated by reference number 319), and two BL16 write accesses (normalized as 2×0.5 in the equation indicated by reference number 319), resulting in a write amplification factor of 6 (e.g., A_{W} 2+1+2+1=6).

In some implementations, a total and/or combined amplification (which may refer to an amplification caused by both read and write operations) of RAID-based memory systems associated with the second access of the extra space (e.g., the BL16 access), such as the memory system described above in connection with the data frame 308, may be determined using the expression A=1.5r+6(1−r), where A corresponds to the total amplification and where r corresponds to the ratio of total commands that are associated with read commands (and thus where 1−r corresponds to the ratio of total commands that are associated with write commands). Thus, for a memory system associated with 100% read commands (e.g., r=1), the total amplification may be A=1.5(1)+6(1−1)=1.5 (e.g., the AR described above in connection with reference number 318), and for a memory system associated with 100% write commands (e.g., r=0), the total amplification may be A=1.5(0)+6(1−0)=6 (e.g., the Aw described above in connection with reference number 319). In a scenario in which a memory system is associated with approximately 70% read commands (e.g., r=0.7), the resulting total amplification becomes A=1.5(0.7)+6(1−0.7)=2.85. Accordingly, memory systems associated with certain RAID-based architectures and/or on-die CRC information, ECC information, and/or metadata may result in high read and/or write amplification, high latency, and low bandwidth, among other examples.

As indicated above, FIGS. 3A-3B are provided as examples. Other examples may differ from what is described with regard to FIGS. 3A-3B.

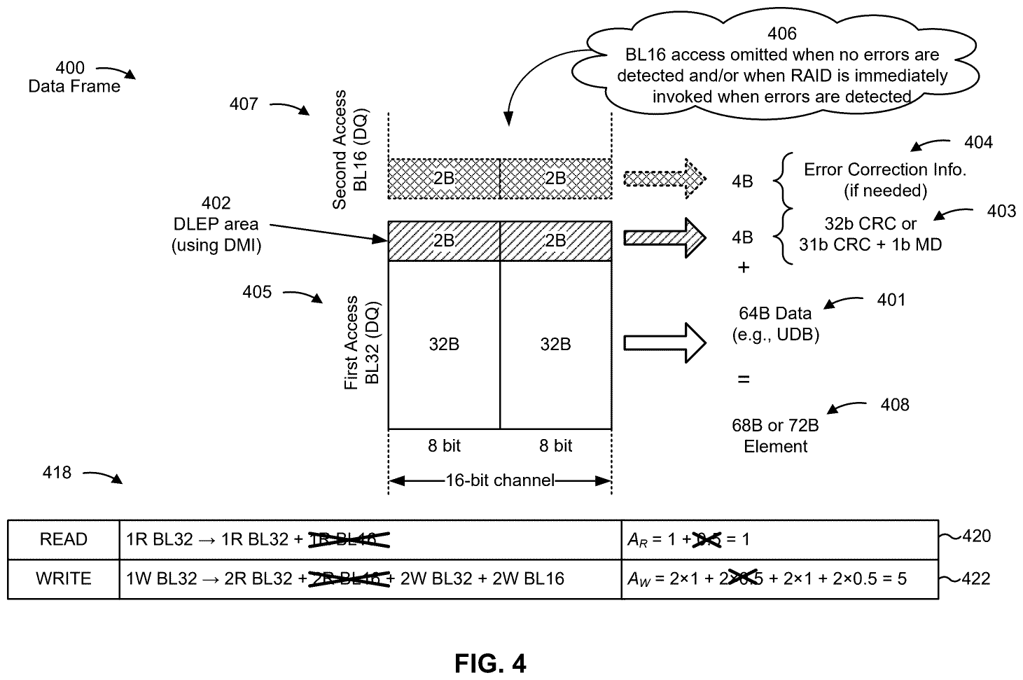

FIG. 4 is a diagram of an example of retrieving user data and CRC information using a single access operation. The operations described in connection with FIG. 4 may be performed by the memory system 110 and/or one or more components of the memory system 110, such as the memory system controller 115, one or more memory devices 120, and/or one or more local controllers 125, and/or the CXL compliant memory system 204 and/or one or more components of the CXL compliant memory system 204, such as the main management subsystem 214 (e.g., a CXL ASIC) and/or one or more memory controllers associated with the CXL device attached memory 218.

In some implementations, a block of user data (e.g., a UDB) may be associated with no bits of metadata or else one bit of metadata. In such implementations, CRC information and the up to one bit of metadata may be stored in a portion of memory accessible by the DMI pins (e.g., a DLEP area). In this way, the second access of the memory components described above in connection with reference number 314 (e.g., the BL16 access) may be omitted by the memory system in certain instances, such as instances in which the UDB includes no bit errors. Put another, because the second access isn't needed to retrieve metadata or similar information associated with the UDB but instead may only be needed to retrieve ECC information, the memory system may omit the second access if the UDB includes no bit errors and thus the ECC information is not needed. In this regard, amplification factors associated with read and/or write commands may be improved, resulting in decreased latency, increased bandwidth, and/or reduced power, computing, and other resource consumption. For example, in implementations in which an accessed block of user data (e.g., an accessed UDB) includes no bit errors, the memory system may be associated with a read amplification factor of 1 (e.g., A_{R}=1) and/or a write amplification factor of 5 (e.g., A_{W}=5), resulting increased memory system bandwidth as compared to a system described above in connection with FIG. 3B (e.g., a system associated with a read amplification factor of 1.5 and/or a write amplification factor of 6).

More particularly, FIG. 4 shows an example data frame 400 associated with reduced read and/or write amplification factors as compared to the example data frame 308 described above in connection with FIG. 3B. The example data frame 400 shown in FIG. 4 is associated with a 64 byte UDB comprised of two memory components (e.g., dies) associated with a single channel (e.g., a 16-bit channel). In some other implementations, a UDB may be associated with more or less data and/or more or less memory components. Each component (e.g., die) may be configured in a by-eight mode (e.g., a x8 mode), meaning that the data stored therein may be accessed using 8 data pins (e.g., DQ pins) per component (e.g., each die may be associated with 8 bits of the 16-bit channel, as shown). Additionally, or alternatively, the data may be accessed using a BL32 access, meaning that during a single access of the memory, the memory system may be capable of accessing up to 32×8 bits of data (e.g., 32 bytes of data), resulting in 64 bytes of total data between the two components, as indicated by reference number 401 (e.g., the two components shown in FIG. 4 may combine to form a 64 byte UDB). Moreover, as indicated by reference number 402, the components may be associated with a storage portion (e.g., a DLEP area) separate from a data storage portion (e.g., a portion separate from the portion used to store the UDB), which may be accessible using a different set of pins, such as DMI pins. In that regard, during an access of the UDB shown in FIG. 4, a memory controller may be capable of accessing, via the channel associated with the UDB, 64 bytes of host data via the DQ pins and 4 bytes of additional data via the DMI pins.

As indicated by reference number 403, in some implementations, such as in implementations in which no metadata is associated with the UDB (e.g., implementations in which no metadata is transmitted via the 16-bit channel when accessing the UDB), the DLEP area may store 32 bits of CRC information. In some other implementations, such as in implementations in which one bit of metadata is associated with the UDB (e.g., implementations in one bit of metadata is to be transmitted via the 16-bit channel when accessing the UDB) the DLEP area may store 31 bits of CRC information and one bit of metadata information.

In some implementations, because all CRC information and metadata information (if any) is contained within the DLEP area (e.g., because all CRC information and metadata (if any) is accessible via the DMI pins), the memory system may forgo a second access (e.g., a BL16 access) when the accessed UDB contains no errors. For example, as indicated by reference number 404, in some implementations the UDB may be associated with additional data (e.g., ECC information and/or similar information) that is stored in an extra area and/or that may be retrieved via a subsequent access of the memory (e.g., DRAM) using the DQ pins. For example, whenever the memory system accesses the UDB via a BL32 access, the memory system may perform an additional access (when needed), such as BL16 access, to retrieve additional information from the extra area, such as ECC information and/or similar information. However, because in this implementation the information stored in the extra area and/or to be accessed by the BL16 access is information only necessary for error correction purposes, the memory system may be configured to forgo the second access (e.g., the BL16 access) when no errors are detected using the CRC information.

More particularly, to access the UDB, the memory system may perform a first access, as indicated by reference number 405, which may include retrieving the UDB by performing a BL32 access using the DQ pins and/or retrieving the CRC information (and the one bit of metadata, when included) using the DMI pins to access the DLEP area. Using the CRC information retrieved using the DMI pins, the memory system may determine whether the retrieved UDB includes any errors. If the UDB does not include any errors, the memory system may omit any subsequent accesses (e.g., the BL16 access), as indicated by reference number 406 and as shown schematically in FIG. 4 by showing the portion associated with the second access (indicated by reference number 407) using broken lines.

However, in the case in which an error is detected in in UDB, the memory system may perform a second access, as indicated by reference number 407, which may include retrieving the ECC information and/or similar information using the DQ pins, such as by performing a BL16 access. In some examples, the ECC information and/or similar information accessed by the second access (e.g., the BL16 access indicated by reference number 407) may include 4 bytes of data, as indicated by reference number 404. Put another way, in implementations involving the ECC information, the extra area associated with the UDB may be 4 bytes. In that regard, even though the BL16 access results in access to 32 bytes of data overall (e.g., burst length 16×16 bit channel=256 bits (32 bytes)), in some implementations only 4 bytes may be relevant to the accessed UDB. Accordingly, as indicated by reference number 408, accessing a certain UDB (e.g., a certain 64 byte UDB) may result in the memory system accessing either a 68 byte element (e.g., in implementations in which the UDB includes no errors, and thus the memory system accesses the 64 bytes of user data and the 4 bytes of CRC information and any metadata while forgoing the second (e.g., BL16) access), or else a 72 byte element (e.g., in implementations in which the UDB includes one or more errors, and thus the memory system accesses the 64 bytes of user data, the 4 bytes of CRC information and any metadata, and the 4 bytes of ECC information using the second (e.g., BL16) access).

For example, in the context of a read operation, the memory system may perform a first access (e.g., a BL32 access) to retrieve a block of user data (e.g., a UDB) using the data pins (e.g., the DQ pins) and to retrieve CRC information associated with the block of user data using the DMI pins. Put another way, the memory system may perform a BL32 access to read the UDB (e.g., to read 64 bytes of user data) via the DQ pins and to read the CRC information (e.g., to read 32 bits of CRC information or 31 bits of CRC information in implementations involving one bit of metadata, among other examples) using the DMI pins. The memory system may use the CRC information to check for data integrity (e.g., the memory system may perform a CRC check on the accessed UDB) and, if the CRC check indicates no errors, the memory system may transmit the data to the host system (e.g., CXL host 202) without performing the subsequent BL16 access. In an event in which the CRC check indicates one or more bit errors in the UDB, the memory system may then perform the second access (e.g., the BL16 access) to retrieve the ECC information in order to attempt to correct the error (or else, in some implementations, immediately invoke a RAID error correction operation, which is described in more detail below). Thereafter, if the one or more bit errors are uncorrectable using the ECC information (which may be determined by using the CRC information to perform a CRC check after applying ECC decoding), the memory system may invoke a RAID error correction operation in order to correct the one or more bit errors.

As indicated by reference number 418, configuring the memory components in the manner described above (e.g., storing CRC information in the DLEP area that is accessed during an initial (e.g., BL32) access and storing ECC information in a location that is accessible using DQ pins during a subsequent (e.g., BL16) access that is accessed only when one or more bit errors are detected) may result in read operations that are associated with a read amplification factor (e.g., A_{R}) of 1 (e.g., when the ECC information is not subsequently accessed) and/or write operations that are associated with a write amplification factor (e.g., A_{W}) of 5 (e.g., when the ECC information is not subsequently accessed). The improved read amplification factor (e.g., A_{R}=1) may be due to the omission of the subsequent access (e.g., the subsequent BL16 access) of the memory components when no errors are detected in the UDB (shown schematically in the equation indicated by reference number 420 by crossing out the variable and numerals corresponding to the omitted operations). Put another way, for a BL32 read access requested by the host system, if the subsequent BL16 access is not necessary (e.g., if the memory system determines, using the UDB and the associated CRC information retrieved via the BL32 access, that the UDB does not include errors and/or that the ECC information is not needed), the memory system omit the BL16 access (as shown by using broken lines in connection with the second access indicated by reference number 407), resulting in read amplification factor of 1.

Similarly, the improved write amplification factor (e.g., A_{W}=5) may be due to the omission of the second access (e.g., the BL16 access) for both the UDB and the associated RAID parity information of the memory components when no errors are detected in the UDB (shown schematically in the equation indicated by reference number 422 by crossing out the variable and numerals corresponding to the omitted operations). Put another way, for a BL32 write access requested by the host system, if the subsequent BL16 access is not necessary (e.g., if the memory system determines, using the UDB and the associated CRC information retrieved via the BL32 access, that the UDB contains no errors and/or that the ECC information is not needed), the memory system may omit the BL16 access for both the UDB and the RAID parity components, resulting in write amplification factor of 5.

In some implementations, the improved write amplification factor (e.g., A_{W}=5) may be enabled when a masked write command is available for memory components in which the DLEP area is being used to store data. Put another way, in order to achieve the improved write amplification factor, a memory system may need to be capable of both retrieving data (e.g., CRC information) via the DMI pins as well as receiving a masked write command. Additionally, or alternatively, in some implementations, the improved write amplification factor (e.g., A_{W}=5) may be enabled when the optional second access (e.g., the BL16 access) contains only ECC information associated with the UDB of the BL32 access. Such implementations may result in an area inefficient solution because, even though the BL16 access results in access to 32 bytes of data overall (e.g., burst length 16×16 bit channel=256 bits (32 bytes)), in some examples only 4 bytes may be relevant to the accessed UDB. Accordingly, in some implementations (e.g., implementations in which a masked write command is not available and/or in which area inefficient solutions are not employed), the operations described herein may result in an improved read amplification factor of 1 (e.g., when the subsequent BL16 access is not needed) while maintaining a write amplification factor of 6.

As described above in connection with FIG. 3B, a total and/or combined amplification of the memory systems that do not omit the second access (e.g., the BL16 access), such as the memory system described above in connection with FIG. 3B, may be determined using the expression A=1.5r+6(1−r), and/or may be equal to 1.5 for 100% read commands (e.g., r=1), 6 for 100% write commands (e.g., r=0), and/or 2.85 for 70% read commands (e.g., r=0.7). On the other hand, a total and/or combined amplification of the memory systems that omit the second access (e.g., the BL16 access) in both read and write commands, such as the memory system described above in connection with FIG. 4, may be determined using the expression A′=r+5(1−r). Thus, for a memory system associated with 100% read commands (e.g., r=1), the total amplification may be A′=1+5(1−1)=1 (e.g., the A_{R} described above in connection with reference number 420), and for a memory system associated with 100% write commands (e.g., r=0), the total amplification may be A′=0+5(1−0)=5 (e.g., the A_{W} described above in connection with reference number 319). In a scenario in which a memory system is associated with approximately 70% read commands (e.g., r=0.7), the resulting total amplification becomes A′=0.7+5(1−0.7)=2.20. Accordingly, in some implementations, the techniques described herein may result in an amplification benefit (which corresponds to A-A′) of 0.65 (e.g., 2.85−2.20=0.65), which is an amplification improvement of approximately 22.81% at 70% read commands.

As described above in connection with FIG. 3B, in some examples the second access (e.g., the BL16 access) may be used by memory systems to retrieve ECC information (e.g., 10 parity bits associated with an SEC code) as well as metadata (e.g., 22 metadata bits). However, as described above in connection with FIG. 4, in implementations in which the second access (e.g., the BL16) may be omitted, the UDB may not be associated with metadata or else any metadata associated with the UDB (e.g., one bit of metadata) may be retrieved via the first access (e.g., the BL32 access). Accordingly, a first-stage error correction capability (e.g., a capability of an error correction operation performed prior to invoking a RAID error correction operation) may be improved as compared to the examples described above in connection with FIG. 3B, because more bits may be available via the second access (e.g., the BL16), when necessary, to be used in connection with an ECC code, resulting in increased bandwidth and/or decreased latency of the memory system as a whole.

For example, the extra area associated with UDB (e.g., the 4 bytes accessible via the BL16 access) may be used to store ECC information associated with an SEC code, such as by storing 10 bits associated with an SEC code (e.g., 10 SEC parity bits), with the remaining 22 bits being used to store information associated with memory management operations, among other examples. In some other implementations, the 4 bytes accessible via the second access (e.g., the BL16 access) may be used to store ECC information associated with an SEC code, such as by storing 10 bits associated with an SEC code (e.g., 10 SEC parity bits), and a size of the extra area associated with the UDB may be reduced to 10 total bits, such as for a purpose of increasing a capacity of RAID elements in the memory array, among other examples.

In some other implementations, the 4 bytes accessible via the second access (e.g., the BL16 access) may be used to store ECC information associated with a double error correction (DEC) code, such as by storing 20 bits associated with a DEC code (e.g., 20 December parity bits). In some other implementations, the 4 bytes accessible via the second access (e.g., the BL16 access) may be used to store ECC information associated with a triple error correction (TEC) code, such as by storing 30 bits associated with a TEC code (e.g., 30 TEC parity bits). In some other implementations, the 4 bytes accessible via the second access (e.g., the BL16 access) may be used to store ECC information associated with a single symbol correction (SSC) code, such as by storing 16 bits associated with an SSC code (e.g., 16 SSC parity bits). In some other implementations, the 4 bytes accessible via the second access (e.g., the BL16 access) may be used to store ECC information associated with a double symbol correction (DSC) code, such as by storing 32 bits associated with a DSC code (e.g., 32 DSC parity bits).

In some other implementations, the UDB may not be associated with an extra area that is accessible via a second access (e.g., the BL16 access). Put another way, in some implementations, the ECC information may be omitted altogether. In such implementations, the memory system may immediately invoke a RAID error correction operation when one or more bit errors are detected in the UDB (e.g., using the CRC information), as indicated by reference number 406. Put another way, the improved amplification factors described above may be achieved by omitting the ECC information (and thus the subsequent BL16 access) altogether, and thus invoking the RAID error correction operation in instances in which any errors are detected in the UDB. Because invoking the RAID error correction operation may be time and/or resource intensive, omitting the extra area altogether may be implemented in memory systems associated with low single-bit error rates, such as memory systems associated with high-quality silicon and/or an on-die ECC, among other examples.

In this way, the operations described above in connection with the example data frame 400 may result in improved read and/or write amplification factors as compared to examples in which the second access (e.g., the BL16 access) is always performed in order to retrieve metadata or other additional information associated with the UDB. Moreover, the operations described above in connection with the example data frame 400 may result in improved in improved ECC procedures in which the second access (e.g., the BL16 access) is performed, resulting in improved memory operations and thus improved bandwidth and reduced latency as well as reduced power, computing, and storage resource consumption.

As indicated above, FIG. 4 is provided as an example. Other examples may differ from what is described with regard to FIG. 4.

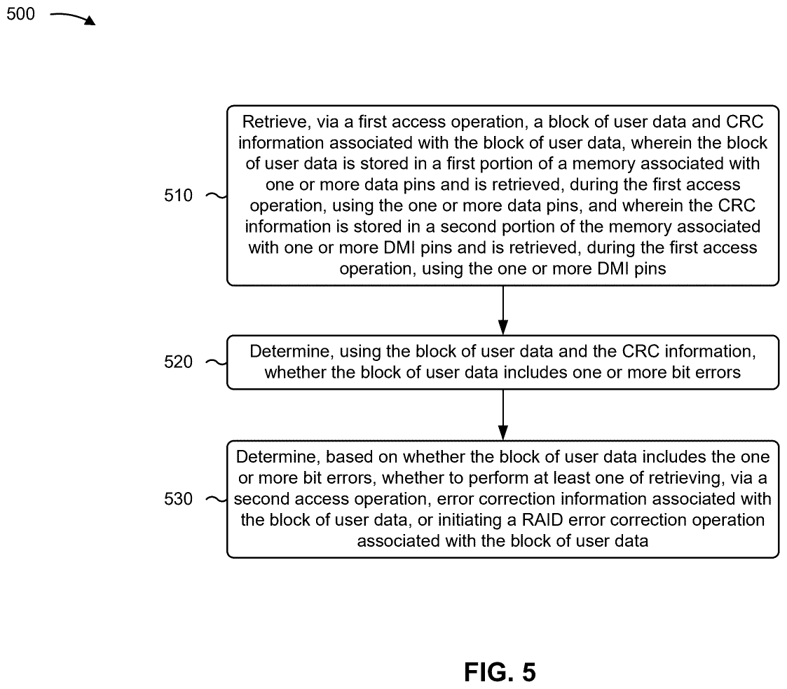

FIG. 5 is a flowchart of an example method 500 associated with retrieving user data and CRC information using a single access operation. In some implementations, a memory system (e.g., memory system 110 and/or CXL compliant memory system 204) may perform or may be configured to perform the method 500. In some implementations, another device or a group of devices separate from or including the memory system (e.g., memory system controller 115, local controller 125, main management subsystem 214, and/or a memory controller associated with the CXL device attached memory 218) may perform or may be configured to perform the method 500. Thus, means for performing the method 500 may include the memory system and/or one or more components of the memory system. Additionally, or alternatively, a non-transitory computer-readable medium may store one or more instructions that, when executed by the memory system, cause the memory system to perform the method 500.

As shown in FIG. 5, the method 500 may include retrieving, via a first access operation, a block of user data and CRC information associated with the block of user data, wherein the block of user data is stored in a first portion of a memory associated with one or more data pins and is retrieved, during the first access operation, using the one or more data pins, and wherein the CRC information is stored in a second portion of the memory associated with one or more DMI pins and is retrieved, during the first access operation, using the one or more DMI pins (block 510). For example, the memory system (e.g., CXL compliant memory system 204) may retrieve, using the BL32 access, the 64 byte UDB of the data frame 400 (e.g., as described above in connection with reference number 401) using one or more data pins (e.g., one or more DQ pins) and may retrieve, during the BL32 access, the CRC information of the data frame 400 (e.g., as described above in connection with reference number 403) using one or more DMI pins (e.g., may retrieve the CRC information from the DLEP area using the one or more DMI pins), as described above in connection with FIG. 4.

As further shown in FIG. 5, the method 500 may include determining, using the block of user data and the CRC information, whether the block of user data includes one or more bit errors (block 520). For example, the memory system (e.g., CXL compliant memory system 204) may determine if the UDB retrieved via the BL32 access includes one or more bit errors using the CRC information retrieved from the DLEP area during the BL32 access, as described above in connection with FIG. 4.

As further shown in FIG. 5, the method 500 may include determining, based on whether the block of user data includes the one or more bit errors, whether to perform at least one of: retrieving, via a second access operation, error correction information associated with the block of user data, or initiating a RAID error correction operation associated with the block of user data (block 530). For example, in instances in which the UDB does not include any errors, the memory system (e.g., CXL compliant memory system 204) may determine to forgo a second access (e.g., a BL16 access), as described above in connection with reference number 406. However, in instances in which the UDB does include errors, the memory system (e.g., CXL compliant memory system 204) may determine to perform the second access (e.g., the BL16 access) in order to retrieve the ECC information (e.g., as described above in connection with reference number 404) in order to correct the errors, or else the memory system (e.g., CXL compliant memory system 204) may immediately invoke a RAID error correction operation, such as in implementations in which the extra area is omitted altogether, as described above in connection with FIG. 4.

The method 500 may include additional aspects, such as any single aspect or any combination of aspects described below and/or described in connection with one or more other methods or operations described elsewhere herein.

In a first aspect, the block of user data includes 64 bytes of user data, and the CRC information includes 32 bits of CRC information. For example, the block of user data may include the 64 byte UDB, as described above in connection with reference number 401, and the DLEP area may include the 32 bits of CRC information, as described above in connection with reference number 403.

In a second aspect, alone or in combination with the first aspect, the block of user data includes 64 bytes of user data, the CRC information includes 31 bits of CRC information, one bit of metadata is stored in the second portion of the memory, and the method 500 further includes retrieving, via the first access operation, and using the one or more DMI pins, the one bit of metadata. For example, the block of user data may include the 64 byte UDB, as described above in connection with reference number 401, and the DLEP area may include the 31 bits of CRC information and one bit of metadata, as described above in connection with reference number 403, that is accessible via the BL32 access by the memory system (e.g., CXL compliant memory system 204).

In a third aspect, alone or in combination with one or more of the first and second aspects, the first access operation is associated with a burst length 32 access operation. For example, the memory system (e.g., CXL compliant memory system 204) may access the 64 byte UDB (e.g., via one or more DQ pins, as described above in connection with reference number 401) and the 32 bits of CRC information and/or metadata (e.g., via one or more DMI pins, as described above in connection with reference number 403) during the BL32 access of the memory components, as described above in connection with FIG. 4.

In a fourth aspect, alone or in combination with one or more of the first through third aspects, determining whether the block of user data includes one or more bit errors includes determining that the block of user data includes no bit errors, determining whether to perform the at least one of retrieving the error correction information or initiating the RAID error correction operation includes determining not to perform the at least one of retrieving the error correction information or initiating the RAID error correction operation based on determining that the block of user data includes no bit errors, and the method 500 further comprises transmitting, to a host system, the block of user data. For example, as described above in connection with FIG. 4, in implementations in which no bit errors are detected at the UDB, the memory system (e.g., CXL compliant memory system 204) may immediately transmit the UDB to the host system (e.g., CXL host 202) without performing the second access (e.g., the BL16 access described above in connection with reference number 407).

In a fifth aspect, alone or in combination with one or more of the first through fourth aspects, determining whether the block of user data includes one or more bit errors includes determining that the block of user data includes one or more bit errors, determining whether to perform the at least one of retrieving the error correction information or initiating the RAID error correction operation includes determining to perform retrieving the error correction information based on determining that the block of user data includes one or more bit errors, and the method 500 further comprises retrieving, via the second access operation, the error correction information. For example, as described above in connection with FIG. 4, in implementations in which bit errors are detected at the UDB, the memory system (e.g., CXL compliant memory system 204) may perform a second access (e.g., the BL16 access described above in connection with reference number 407), such as for a purpose of retrieving ECC information associated with the UDB.

In a sixth aspect, alone or in combination with one or more of the first through fifth aspects, the second access operation is associated with a burst length 16 access operation. For example, the memory system (e.g., CXL compliant memory system 204) may perform the BL16 access described above in connection with reference number 407 to retrieve the ECC information.

In a seventh aspect, alone or in combination with one or more of the first through sixth aspects, the method 500 includes determining that the one or more bit errors are uncorrectable using the error correction information, and initiating the RAID error correction operation based on determining that the one or more bit errors are uncorrectable using the error correction information. For example, in instances in which the one or more bit errors cannot be corrected using the ECC information (e.g., as described above in connection with reference number 404) or otherwise, the memory system (e.g., CXL compliant memory system 204) may invoke a RAID error correction operation (e.g., the RAID error correction operation described above in connection with FIG. 3A and/or a similar RAID error correction operation) in order to correct the one or more bit errors, as described above in connection with FIG. 4.

In an eighth aspect, alone or in combination with one or more of the first through seventh aspects, the error correction information is associated with at least one of a single error correction code associated with 10 parity bits, a double error correction code associated with 20 parity bits, a triple error correction code associated with 30 parity bits, a single symbol correction code associated with 16 parity bits, or a double symbol correction code associated with 32 parity bits. For example, as described above in connection with FIG. 4, the 4 bytes accessible via the second access (e.g., the extra area accessible via the BL16 access, as described above in connection with reference number 407) may store 10 SEC parity bits, 20 December parity bits, 30 TEC parity bits, 16 SSC parity bits, or 32 DSC parity bits, among other examples.

In a ninth aspect, alone or in combination with one or more of the first through eighth aspects, determining whether the block of user data includes one or more bit errors includes determining that the block of user data includes one or more bit errors, determining whether to perform the at least one of retrieving the error correction information or initiating the RAID error correction operation includes determining to initiate the RAID error correction operation based on determining that the block of user data includes one or more bit errors, and the method 500 further comprises initiating the RAID error correction operation. For example, as described above in connection with FIG. 4, in some implementations there may be no extra area associated with the UDB (e.g., such as in implementations involving memory systems associated with a high-quality silicon and/or an on-die ECC, among other examples), and thus, upon detecting one or more bit errors in the UDB, the memory system (e.g., CXL compliant memory system 204) may immediately invoke a RAID error correction operation in order to correct the detected errors.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory system includes one or more components configured to: retrieve, via a first access operation, a block of user data and cyclic redundancy check (CRC) information associated with the block of user data, wherein the block of user data is stored in a first portion of a memory associated with one or more data pins and is retrievable, during the first access operation, using the one or more data pins, and wherein the CRC information is stored in a second portion of the memory associated with one or more data mask inversion (DMI) pins and is retrievable, during the first access operation, using the one or more DMI pins; determine, using the block of user data and the CRC information, whether the block of user data includes one or more bit errors; and determine, based on whether the block of user data includes the one or more bit errors, whether to perform at least one of: retrieving, via a second access operation, error correction information associated with the block of user data, or initiating a redundant array of independent disks (RAID) error correction operation associated with the block of user data.

In some implementations, a method includes retrieving, by a memory controller and via a first access operation, a block of user data and cyclic redundancy check (CRC) information associated with the block of user data, wherein the block of user data is stored in a first portion of a memory associated with one or more data pins and is retrieved, during the first access operation, using the one or more data pins, and wherein the CRC information is stored in a second portion of the memory associated with one or more data mask inversion (DMI) pins and is retrieved, during the first access operation, using the one or more DMI pins; determining, by the memory controller and using the block of user data and the CRC information, whether the block of user data includes one or more bit errors; and determining, by the memory controller and based on whether the block of user data includes the one or more bit errors, whether to perform at least one of: retrieving, via a second access operation, error correction information associated with the block of user data, or initiating a redundant array of independent disks (RAID) error correction operation associated with the block of user data.

In some implementations, a compute express link (CXL) compliant memory system includes a dynamic random access memory (DRAM); and a memory controller operatively connected to the DRAM and configured to: retrieve, from the DRAM via a burst length 32 (BL32) access of the DRAM, a user data block (UDB) and cyclic redundancy check (CRC) information associated with the UDB, wherein the UDB is stored in a first portion of the DRAM and is retrievable, during the BL32 access of the DRAM, using one or more DQ pins, and wherein the CRC information is stored in a second portion of the DRAM and is retrievable, during the BL32 access of the DRAM, using one or more data mask inversion (DMI) pins; determine, using the UDB and the CRC information, whether the UDB includes one or more bit errors; and determine, based on whether the UDB includes the one or more bit errors, whether to perform at least one of: retrieving, via a burst length 16 (BL16) access of the DRAM, error correction information associated with the UDB, or initiating a redundant array of independent disks (RAID) error correction operation associated with the UDB.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
retrieve, via a first access operation, a block of user data and cyclic redundancy check (CRC) information associated with the block of user data,
wherein the block of user data is stored in a first portion of a memory associated with one or more data pins and is retrievable, during the first access operation, using the one or more data pins, and
wherein the CRC information is stored in a second portion of the memory associated with one or more data mask inversion (DMI) pins and is retrievable, during the first access operation, using the one or more DMI pins;
determine, using the block of user data and the CRC information, whether the block of user data includes one or more bit errors; and
determine, based on whether the block of user data includes the one or more bit errors, whether to perform at least one of:
retrieving, via a second access operation, error correction information associated with the block of user data, or
initiating a redundant array of independent disks (RAID) error correction operation associated with the block of user data.

2. The memory system of claim 1, wherein the block of user data includes 64 bytes of user data, and
wherein the CRC information includes 32 bits of CRC information.

3. The memory system of claim 1, wherein the block of user data includes 64 bytes of user data,
wherein the CRC information includes 31 bits of CRC information,
wherein one bit of metadata is stored in the second portion of the memory, and
wherein the one or more components are further configured to retrieve, via the first access operation and using the one or more DMI pins, the one bit of metadata.

4. The memory system of claim 1, wherein the first access operation is associated with a burst length 32 access operation.

5. The memory system of claim 1, wherein the one or more components, to determine whether the block of user data includes one or more bit errors, are configured to determine that the block of user data includes no bit errors,
wherein the one or more components, to determine whether to perform the at least one of retrieving the error correction information or initiating the RAID error correction operation, are configured to determine not to perform the at least one of retrieving the error correction information or initiating the RAID error correction operation based on determining that the block of user data includes no bit errors, and
wherein the one or more components are further configured to transmit, to a host system, the block of user data.

6. The memory system of claim 1, wherein the one or more components, to determine whether the block of user data includes one or more bit errors, are configured to determine that the block of user data includes one or more bit errors,
wherein the one or more components, to determine whether to perform the at least one of retrieving the error correction information or initiating the RAID error correction operation, are configured to determine to perform retrieving the error correction information based on determining that the block of user data includes one or more bit errors, and
wherein the one or more components are further configured to retrieve, via the second access operation, the error correction information.

7. The memory system of claim 6, wherein the second access operation is associated with a burst length 16 access operation.

8. The memory system of claim 6, wherein the one or more components are further configured to:
determine that the one or more bit errors are uncorrectable using the error correction information; and
initiate the RAID error correction operation based on determining that the one or more bit errors are uncorrectable using the error correction information.

9. The memory system of claim 6, wherein the error correction information is associated with at least one of:
a single error correction code associated with 10 parity bits,
a double error correction code associated with 20 parity bits,
a triple error correction code associated with 30 parity bits,
a single symbol correction code associated with 16 parity bits, or
a double symbol correction code associated with 32 parity bits.

10. The memory system of claim 1, wherein the one or more components, to determine whether the block of user data includes one or more bit errors, are configured to determine that the block of user data includes one or more bit errors,
wherein the one or more components, to determine whether to perform the at least one of retrieving the error correction information or initiating the RAID error correction operation, are configured to determine to initiate the RAID error correction operation based on determining that the block of user data includes one or more bit errors, and
wherein the one or more components are further configured to initiate the RAID error correction operation.

11. A method, comprising:
retrieving, by a memory controller and via a first access operation, a block of user data and cyclic redundancy check (CRC) information associated with the block of user data,
wherein the block of user data is stored in a first portion of a memory associated with one or more data pins and is retrieved, during the first access operation, using the one or more data pins, and
wherein the CRC information is stored in a second portion of the memory associated with one or more data mask inversion (DMI) pins and is retrieved, during the first access operation, using the one or more DMI pins;
determining, by the memory controller and using the block of user data and the CRC information, whether the block of user data includes one or more bit errors; and
determining, by the memory controller and based on whether the block of user data includes the one or more bit errors, whether to perform at least one of:
retrieving, via a second access operation, error correction information associated with the block of user data, or
initiating a redundant array of independent disks (RAID) error correction operation associated with the block of user data.

12. The method of claim 11, wherein the block of user data includes 64 bytes of user data, and
wherein the CRC information includes 32 bits of CRC information.

13. The method of claim 11, wherein the block of user data includes 64 bytes of user data,
wherein the CRC information includes 31 bits of CRC information,
wherein one bit of metadata is stored in the second portion of the memory, and
wherein the method further comprises retrieving, by the memory controller, via the first access operation, and using the one or more DMI pins, the one bit of metadata.

14. The method of claim 11, wherein the first access operation is associated with a burst length 32 access operation.

15. The method of claim 11, wherein determining whether the block of user data includes one or more bit errors includes determining that the block of user data includes no bit errors,
wherein determining whether to perform the at least one of retrieving the error correction information or initiating the RAID error correction operation includes determining not to perform the at least one of retrieving the error correction information or initiating the RAID error correction operation based on determining that the block of user data includes no bit errors, and
wherein the method further comprises transmitting, by the memory controller and to a host system, the block of user data.

16. The method of claim 11, wherein determining whether the block of user data includes one or more bit errors includes determining that the block of user data includes one or more bit errors,
wherein determining whether to perform the at least one of retrieving the error correction information or initiating the RAID error correction operation includes determining to perform retrieving the error correction information based on determining that the block of user data includes one or more bit errors, and
wherein the method further comprises retrieving, by the memory controller and via the second access operation, the error correction information.

17. The method of claim 16, wherein the second access operation is associated with a burst length 16 access operation.

18. The method of claim 16, further comprising:
determining, by the memory controller, that the one or more bit errors are uncorrectable using the error correction information; and
initiating, by the memory controller, the RAID error correction operation based on determining that the one or more bit errors are uncorrectable using the error correction information.

19. The method of claim 16, wherein the error correction information is associated with at least one of:
a single error correction code associated with 10 parity bits,
a double error correction code associated with 20 parity bits,
a triple error correction code associated with 30 parity bits,
a single symbol correction code associated with 16 parity bits, or
a double symbol correction code associated with 32 parity bits.

20. The method of claim 11, wherein determining whether the block of user data includes one or more bit errors includes determining that the block of user data includes one or more bit errors,
wherein determining whether to perform the at least one of retrieving the error correction information or initiating the RAID error correction operation includes determining to initiate the RAID error correction operation based on determining that the block of user data includes one or more bit errors, and
wherein the method further comprises initiating the RAID error correction operation.

21. A compute express link (CXL) compliant memory system, comprising:
a dynamic random access memory (DRAM); and
a memory controller operatively connected to the DRAM and configured to:
retrieve, from the DRAM via a burst length 32 (BL32) access of the DRAM, a user data block (UDB) and cyclic redundancy check (CRC) information associated with the UDB,
wherein the UDB is stored in a first portion of the DRAM and is retrievable, during the BL32 access of the DRAM, using one or more DQ pins, and
wherein the CRC information is stored in a second portion of the DRAM and is retrievable, during the BL32 access of the DRAM, using one or more data mask inversion (DMI) pins;
determine, using the UDB and the CRC information, whether the UDB includes one or more bit errors; and
determine, based on whether the UDB includes the one or more bit errors, whether to perform at least one of:
retrieving, via a burst length 16 (BL16) access of the DRAM, error correction information associated with the UDB, or
initiating a redundant array of independent disks (RAID) error correction operation associated with the UDB.

22. The CXL compliant memory system of claim 21, wherein the UDB includes 64 bytes of user data, and
wherein the CRC information includes 32 bits of CRC information.

23. The CXL compliant memory system of claim 21, wherein the UDB includes 64 bytes of user data,
wherein the CRC information includes 31 bits of CRC information,
wherein one bit of metadata is stored in the second portion of the DRAM, and
wherein the memory controller is further configured to retrieve, via the BL32 access of the DRAM and using the one or more DMI pins, the one bit of metadata.

24. The CXL compliant memory system of claim 21, wherein the memory controller, to determine whether the UDB includes one or more bit errors, is configured to determine that the UDB includes no bit errors,
wherein the memory controller, to determine whether to perform the at least one of retrieving the error correction information or initiating the RAID error correction operation, is configured to determine not to perform the at least one of retrieving the error correction information or initiating the RAID error correction operation based on determining that the UDB includes no bit errors, and
wherein the memory controller is further configured to transmit, to a host system, the UDB.

25. The CXL compliant memory system of claim 21, wherein the memory controller, to determine whether the UDB includes one or more bit errors, is configured to determine that the UDB includes one or more bit errors,
wherein the memory controller, to determine whether to perform the at least one of retrieving the error correction information or initiating the RAID error correction operation, is configured to determine to perform retrieving the error correction information based on determining that the UDB includes one or more bit errors,
wherein the memory controller is further configured to retrieve, via the BL16 access of the DRAM, the error correction information.
